(19) United States
(12) Patent Application Publication
(10) Pub. No.: US 2023/0126717 A1
(43) Pub. Date: Apr. 27, 2023

(54) SYSTEM AND METHOD FOR GENERATING A SET OF ORDERED DEPLOYMENT DOMAINS

(71) Applicant: FLIPKART INTERNET PRIVATE LIMITED, Bengaluru (IN)

(72) Inventor: Anuj Agrawal, Bengaluru (IN)

(73) Assignee: FLIPKART INTERNET PRIVATE LIMITED, Bengaluru (IN)

(21) Appl. No.: 17/973,044

(22) Filed: Oct. 25, 2022

(30) Foreign Application Priority Data
Oct. 27, 2021 (IN) 202141049156

(51) Int. Cl. G06F 11/00; G06F 9/50

(52) U.S. Cl. CPC G06F 11/004; G06F 9/5038; G06F 2201/815

(57) ABSTRACT

A system and method for generating a set of ordered deployment domains to verify and deploy a change in a plurality of electronic devices' variants. The method encompasses receiving, at a processing unit [102], unordered deployment domain/s. Further the method encompasses identifying, by an identification unit [104], a set of plurality of electronic devices' variants present in each deployment domain of the unordered deployment domain/s. The method thereafter encompasses identifying, by the identification unit [104], a number of electronic devices' variants in each set of plurality of electronic devices' variants. Further the method encompasses ordering, by the processing unit [102], each deployment domain of the unordered deployment domain/s in a specific order based on the identified number of electronic devices' variants in each set of plurality of electronic devices' variants, to generate the set of ordered deployment domains based on the specific order.

### RELATED APPLICATION

This application claims priority under 35 U.S.C. § 119 to Indian Patent Application No. 202141049156, filed on Oct. 27, 2021, the entire contents of which are incorporated herein by reference.

### TECHNICAL FIELD

The present invention generally relates to the field of data center infrastructure management and more particularly, to a system and method for generating a set of ordered deployment domains to verify and deploy a change in a plurality of electronic devices' variants.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With the advancement and rapid growth in various technologies and digital data over the past few years, the requirement of data centre infrastructure management (Infrastructure as a Service Provider) also increased to a great extent. To facilitate various digital services efficiently and effectively a number of electronic devices/servers are generally deployed by a service provider/data centre owner in a data centre. These electronic devices/servers can be of the same type or different types. Furthermore, it is also possible that similar type of electronic devices/servers (such as electronic devices having same hardware configuration and the like parameters) are deployed together in a data centre but these electronic devices may have different variants. As there can be a number of electronic devices/servers having various variants in a deployment, it is important to manage all such variants efficiently to deploy a change in such deployment.

For instance, to deploy a change in a cloud environment, generally there is a requirement to deploy a minor software change that just requires to upgrade a version of an application software or some configuration parameters of the same application software version. Such application software deployments do not typically have to worry about the variety of hardware/firmware/OS on which it is to be deployed since they are abstracted from such variety. However, in some cases, where the underlying hardware or OS is changing (say, for example, when the application owner decides to upgrade the OS version), cloud application owners typically still do not have to worry about the variety of hardware/firmware/OS since they completely move from one variety to another. The usual concern for such deployments is to ensure that no more than a certain threshold percentage/number of servers/electronic devices serving the application should be impacted, if a deployment turns out to be a bad deployment resulting in a breakage of some sorts. Furthermore, the known methods like blue green deployments or rolling deployments are typically used for such kinds of deployments.

On the other hand, data center owners typically have a wide variety of devices (servers/electronic devices) installed. For example, to avoid a vendor lock-in, a data center may have multiple varieties of physical servers even with the same hardware configuration just because the servers or parts of servers are sourced from different vendors and/or have different firmwares installed on them. Multiple such dimensions need to be considered when classifying devices of the same nature into multiple varieties. Few examples of potential dimensions to be considered for variations are:
hardware make, version, configuration
firmware make, version, configuration
operating system make, version, configuration
device or component drivers, version, configuration
other software components, version, configuration

For example, for an infrastructure as a service (IaaS) provider, servers of the same hardware configuration sourced from the same hardware vendor having the same firmware and OS installed, may just differ in the virtualization technology they use to provide virtual servers and, hence, could be considered as two different variants.

Also, IaaS providers typically do not just apply a rule that no more than a certain threshold percentage/number of their devices/servers should be impacted while carrying out a deployment. This is so because application servers hosted on the data center infrastructure may be concentrated on the devices that may be chosen in a set of machines without violating the threshold defined at the data center level. As a result, IaaS providers need to look at the entire map of the application servers to the real infrastructure devices while creating sets of devices for simultaneous deployment and are constrained by the promised service level agreement for the application servers in terms of the number of application servers or subset of application servers that could go down at the same time while deploying a change in the infrastructure.

Furthermore, a currently known method to solve this problem of dividing infrastructure devices into deployment domains for carrying out a deployment is Planned Maintenance Domain (PMD). The PMD solution tries to create dynamic deployment domains of infrastructure pieces, by looking at the map of application servers on physical infrastructure and dividing the infrastructure devices on-demand, into domains such that the promised service level (typically, no more than a certain percentage/number of application servers of any application cluster are impacted while carrying out deployment in one domain at a time) are maintained. Also, one other currently known method to solve this problem of dividing infrastructure devices into deployment domains for carrying out a deployment is Static Maintenance Domain (SMD). The SMD method tries to create static deployment domains of infrastructure devices and expects that the application servers should be distributed among these domains in such a way that the promised service level (typically, on the number or subset of application servers going down simultaneously) is not violated. This allows the infrastructure provider to carry out deployment in pre-defined domains one at a time without worrying about the impact caused on application servers. Also, yet another known method to solve this problem of dividing infrastructure devices into deployment domains for carrying out a deployment is PMD-SMD Hybrid. The hybrid method is to create static deployment domains of infrastructure devices as defined by the SMD method and then distribute application servers among these domains on a best effort basis. To run actual deployments, the PMD method can be tweaked to make it consider SMD, while creating domains.

It is noteworthy that all such known solutions generate an unordered set of deployment domains which can be taken up for deployment in any order. However, none of the above methods consider the variety of devices present in a data center for deployments. This is important because the changes deployed by an IaaS provider in the infrastructure devices can potentially behave differently with variations in the dimensional values of the variety of devices. In large scale data centers, the variety is often wide enough that makes it unpragmatic to test and certify a change on every variant of the devices before starting a deployment. A common strategy could be to test the change in a few variants and then hope that the change would work on all variants. To increase the chances of finding a problem with a deployment early in the testing, the variants chosen during testing can be the ones that differ the most among the various dimensions. As the change is rolled out, the person/user or team rolling out the change needs to keep a vigil to look for issues that can happen because the change may fail to work the intended way on some variant(s).

Example: Consider a data center with a fleet of physical servers that uses only Linux distributions for operating systems. Let there be x different server hardware configurations installed with y different Linux distributions and z different versions of each of the Linux distributions. Thus, to deploy a software change on the fleet of servers, a change should ideally be tested and certified on x*y*z variants which could be a large number to be able to pragmatically certify every change on all variants before deployment to production. Furthermore, in the given example let us say an IaaS provider has a change to be deployed which makes use of a sudo command in a non-interactive mode, a flag that is used to invoke sudo in the non-interactive mode can be expressed in two forms: short form -n or long form—non-interactive. This is such a basic command that it is easy to assume that this command is supported by all Linux distributions and all distribution versions of all such distributions. As a result, the provider may choose to certify for a handful of Linux distributions that are used in production and maybe just one version of all such distributions. For instance, if the proposed change invokes the command with the long form of the non-interactive flag but the long form happens to be recognized by all but one variant. Thus, even if the IaaS provider ends up certifying a change on a handful of variants which may certify on all hardware configurations and operating system distributions but not all versions of all operating system distributions, chances are high that the provider may later find out at some point during the deployment that the long form does not work on all variants. As the deployment progresses and the problem is eventually identified, it may make sense to rework the change with the short form of the flag for uniformity, thus, requiring a re-deployment for the entire fleet. The magnitude and cost of re-deployment will depend on the nature of the problem and when the problem is identified during the deployment process. Therefore, the above example provides a simple scenario in which if a problem is found in late stages of a deployment, the cost of finding such a problem is too high as the entire change initiation and deployment process has to be re-done.

Furthermore, as the currently known solutions fail to consider the variety of devices present in a data center for deployments, there arises a requirement to provide a solution that considers all variants of devices present in a data center for deployments. Also, as the currently known solutions fail to provide an ordered set of deployment domains which can be taken up for deployment in a particular order, there is an additional need in the art to provide a solution to generate the ordered set of deployment domains. Therefore, there is a need in the art to provide a novel solution to generate an efficient and effective set of ordered deployment domains to verify and deploy a change in a plurality of electronic devices' variants.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a system and method for generating a set of ordered deployment domains to verify and deploy a change in a plurality of electronic devices' variants present in one or more deployment domains of the set of ordered deployment domains. Also, an object of the present invention is to verify and deploy a change on all variants present in a deployment with a minimum possible number of devices, before the change is rolled to the entire fleet of devices. Another object of the present invention is to help in detecting deployment issues earlier during a deployment cycle, where it is practically impossible to try out a change on all variants of devices. Also, an object of the present invention is to increase confidence early on a deployment cycle that a change being deployed will not result in issues on some variant of devices. Another, object of the present invention is to create an ordered list of deployment domains. Further, an object of the present invention is to take into account the different variants of devices of a kind while creating deployment domains. Another object of the present invention is to maximize the number of variants covered with each deployment domain picked in the order of deployment. Also, an object of the present invention is to create initial deployment domains with minimal number of devices as it works towards verifying that a change works the intended way on all variants. Another object of the present invention is to adhere to a promised service level agreement (SLA) on a number and/or kind and/or subset, etc. of machines that can be brought down as part of a single deployment. Yet another object of the present invention is to use various deployment methods or strategies to carry out deployment on devices present in a deployment domain based on verifying that a change verified on a specific number of devices works the intended way on all variants present in the deployment domain.

In order to achieve the aforementioned objectives, the present invention provides a method and system for generating a set of ordered deployment domains to verify and deploy a change in a plurality of electronic devices' variants present in each deployment domain from the set of ordered deployment domains.

An aspect of the present invention relates to a method for generating a set of ordered deployment domains to verify and deploy a change in a plurality of electronic devices' variants present in each deployment domain of the set of ordered deployment domains. The method comprises receiving, at a processing unit, one or more unordered deployment domains. Further the method thereafter leads to identifying, by an identification unit, a set of plurality of electronic devices' variants present in each deployment domain of the one or more unordered deployment domains. The method thereafter encompasses identifying, by the identification unit, a number of electronic devices' variants in each set of plurality of electronic devices' variants. Further the method encompasses ordering, by the processing unit, each deployment domain of the one or more unordered deployment domains in a specific order based on the identified number of electronic devices' variants in each set of plurality of electronic devices' variants, to generate the set of ordered deployment domains based on the specific order. Also, the method further comprises verifying and deploying a change in one or more electronic devices' variants present in each set of plurality of electronic devices' variants, wherein the change in the one or more electronic devices' variants is verified and deployed based on the specific order of each deployment domain in the set of ordered deployment domains.

Another aspect of the present invention relates to a system for generating a set of ordered deployment domains to verify and deploy a change in a plurality of electronic devices' variants present in each deployment domain of the set of ordered deployment domains. The system comprises a processing unit, configured to receive one or more unordered deployment domains. Also, the system further comprises an identification unit, configured to identify a set of plurality of electronic devices' variants present in each deployment domain of the one or more unordered deployment domains. The identification unit is further configured to identify a number of electronic devices' variants in each set of plurality of electronic devices' variants. Also, the processing unit is thereafter configured to order, each deployment domain of the one or more unordered deployment domains in a specific order, based on the identified number of electronic devices' variants in each set of plurality of electronic devices' variants, to generate the set of ordered deployment domains based on the specific order. Further, the processing unit is configured to verify and deploy a change in one or more electronic devices' variants present in each set of plurality of electronic devices' variants, wherein the change in the one or more electronic devices' variants is verified and deployed based on the specific order of each deployment domain in the set of ordered deployment domains.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for generating a set of ordered deployment domains, in accordance with exemplary embodiments of the present invention.

FIG. 2 illustrates an exemplary method flow diagram [200], depicting a method for generating a set of ordered deployment domains, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section, the existing technologies have many limitations and in order to overcome at least some of the limitations of the prior known solutions, the present disclosure provides a solution for generating a set of ordered deployment domains to verify and deploy a change in a plurality of electronic devices' variants present in a deployment domain. More particularly, deployment of changes by an IaaS provider in one or more infrastructure devices/deployment domains using one or more known solutions generally results in one or more deployment issues, as some variants of one or more electronic devices/servers in a deployment domain/infrastructure may discover late during the deployment process. Also, it is possible that in the known solutions, some of the variants in infrastructure devices are part of domains that are picked last in the deployment process and hence, issues with such variants are found out towards the fag end of the deployment process. This could potentially mean finding another patch to fix the issue for the entire fleet of devices and carry out the complete deployment cycle all over again. Therefore, the present invention to overcome the limitations of the prior known solutions provides a system and method to create a set of deployment domains that help to discover issues with various variants of devices early during a deployment process. More specifically, the present invention encompasses creating ordered deployment domains (set of ordered deployment domains). In an implementation, the set of ordered deployment domains are generated based on ordering one or more deployment domains based on maximizing a cumulative number of device variants each domain brings along with it. Also, in another implementation, the set of ordered deployment domains are generated in such a way that with each deployment domain that is picked for deployment in that order, a cumulative number of variants picked for deployment is maximized with minimum number of devices in each domain, while also applying one or more additional deployment constraints for instance ensuring that no more than a certain percentage/number of any of the user clusters (electronic devices/servers) hosted on an infrastructure are impacted etc. It will be appreciated by those skilled in the art that the afore-mentioned deployment constraint is only exemplary, and any other deployment constraint may also be used depending upon the use case. After all the variants are covered and the change(s) are verified to work the intended way with all the variants with the help of these ordered deployment domains, the present invention encompasses continuing deployment with one or more usual methods.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a device”, “an equipment”, “a user equipment”, “a user device”, “a smart-user-device”, “a smart-device”, “an electronic device”, “a mobile device”, “a handheld device”, “a communication device” and the like may be any electrical, electronic and/or computing device or equipment, capable of implementing the features of the present disclosure. In an implementation the user equipment/device may include, but is not limited to, a mobile phone, smart phone, laptop, a general-purpose computer, desktop, personal digital assistant, tablet computer, wearable device or any other computing device which is capable of implementing the features of the present disclosure. Further, in another implementation, the user devices/devices/electronic devices may be any server devices having one or more hardware configurations, firmware variations, operating system variations, versions variations, device or component drivers' variations or other software components variations. Further, in an implementation two or more devices/servers can be of same hardware configurations but different variants. Also, the user device/servers may contain at least one input means configured to receive an input from at least one of a users, a processing unit, a storage unit, an identification unit, a transceiver unit, a server unit and any other such unit(s) which are obvious to the person skilled in the art and are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

The present disclosure is further explained in detail below with reference now to the drawings.

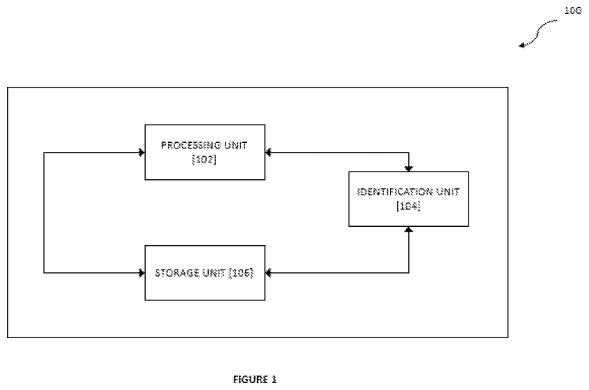

Referring to FIG. 1, an exemplary block diagram of a system [100] for generating a set of ordered deployment domains, in accordance with exemplary embodiments of the present invention is shown. As shown in FIG. 1, the system encompasses at least one processing unit [102], at least one identification unit [104] and at least one storage unit [106]. In an implementation, the system [100] may reside in a server device. All of the components/units of the system [100] are assumed to be connected to each other unless otherwise indicated below. Also, in FIG. 1 only a few units are shown, however, the system [100] may comprise multiple such units or the system [100] may comprise any such numbers of said units, obvious to a person skilled in the art or as required to implement the features of the present disclosure.

The system [100] is configured to generate the set of ordered deployment with the help of the interconnection between the components/units of the system [100].

The processing unit [102] is configured to receive one or more unordered deployment domains. The one or more unordered deployment domains are created via at least one generally followed method of creation of an unordered deployment domain. For example, the one or more unordered deployment domains may be created by at least one of a Planned Maintenance Domain (PMD) method, Static Maintenance Domain (SMD) method, PMD-SMD Hybrid Maintenance Domain method and the like methods known in the art. Also, the one or more unordered deployment domains are created based on one or more required constraints such as including but not limited to a pre-defined SLA threshold to ensure that no more than a certain percentage/number/sets of electronic devices hosted on an infrastructure platform/deployment platform are impacted. In an example, the predefined SLA may be a threshold value indicating not more than a certain number or percentage of machines (i.e. electronic devices) hosted on the service provider infrastructure would be impacted simultaneously as part of a change or deployment being carried out by the infrastructure provider. In another example, the promised SLA may be on one or more attributes of the machines indicating that machines with the same attribute values would be impacted simultaneously as part of a change or deployment being carried out by the infrastructure provider; in other words, machines with two different values of a promised attribute or attributes will not be impacted simultaneously as part of a change or deployment being carried out by the infrastructure provider. Likewise, there can be many different ways in which SLAs could be promised by the provider. Further, once the one or more unordered deployment domains are created, the same are received at the processing unit [102].

Thereafter, the identification unit [104] connected to the processing unit [102], is configured to identify a set of plurality of electronic devices' variants present in each deployment domain of the one or more unordered deployment domains. For example, if 5 unordered deployment domains are received at the processing unit [102] and each unordered deployment domain comprises a set of 25 electronic devices' variants (i.e. the set of plurality of electronic devices' variants). The identification unit [104] is then configured to identify in each of the 5 unordered deployment domains a corresponding set of plurality of electronic devices' variants (i.e. a corresponding set of 25 electronic devices' variants).

Also, the identification unit [104] is further configured to identify a number of electronic devices' variants in each set of plurality of electronic devices' variants. For instance, in the above example, the identification unit [104] is configured to identify a number of electronic devices' variants in each set of 25 electronic devices' variants. Therefore, for each unordered deployment domain, a set of plurality of electronic devices' variants, and a number of electronic devices' variants present in said set of plurality of electronic devices' variants is identified by the identification unit [104].

Further, the processing unit [102] is configured to order, each deployment domain of the one or more unordered deployment domains in a specific order, based on the identified number of electronic devices' variants in each set of plurality of electronic devices' variants, to generate the set of ordered deployment domains based on the specific order. For example, if 3 unordered deployment domains A, B and C are received at the processing unit [102] and a set of plurality of electronic devices' variants corresponding to each of the A, B and C deployment domains comprising 15, 12 and 19 variants of an electronic device, respectively, is identified by the identification unit [104]. Thereafter, in the given example, the processing unit [104] is configured to order A, B and C deployment domains based on the identified number of electronic devices' variants in the set of plurality of electronic devices' variants corresponding to the A, B and C deployment domains i.e. the identified 15, 12 and 19 electronic device variants. Thereafter, once the A, B and C deployment domains are ordered in a specific order, a set of the ordered deployment domains based on the order of the A, B and C deployment domains is generated.

In an implementation, the processing unit [102] is further configured to generate the set of ordered deployment domains based on maximizing a cumulative number of electronic devices' variants with each set of plurality of electronic devices' variants of each deployment domain. More specifically, the processing unit [104] is firstly configured to identify one or more overlapped variants in two or more sets of plurality of electronic devices' variants of one or more deployment domains. Thereafter, the processing unit [104] is configured to generate the set of ordered deployment domains such that a deployment domain having a maximum number of variants will rank first followed by a deployment domain from among the remaining deployment domains having: maximum number of unique variants that are not already covered by the deployment domains that have already been ordered. For example, if there are three deployment domains X, Y and Z, wherein each of the three deployment domains having 10 variants, 7 variants and 8 variants respectively. Also, a total number of unique variants in the given example is 15 and there are 4 overlapping variants in the deployment domains X and Y and 6 overlapping variants in the deployment domains X and Z. Further, in the given example a set of ordered deployment domains will be generated based on the implementation of the features of the present invention by firstly selecting the deployment domain with maximum number of variants i.e. X, followed by Y (i.e. deployment domain with least number of overlapped variants and higher number of new variants (i.e. 3 non-overlapped variants)) and Z (i.e. deployment domain with maximum number of overlapped variants and a lower number of new variants (i.e. 2 non-overlapped variants)), respectively. Therefore, in the given example a set of the ordered deployment domains based on the order of the X, Y and Z deployment domains i.e. X, Y and Z, is generated. In another example, if there are three deployment domains X, Y and Z, wherein each of the three deployment domains comprises 10 variants, 7 variants and 8 variants respectively. Also, in the given example if X and Y have 4 common/overlapping variants and X and Z also have 4 common variants. A set of the ordered deployment domains is generated based on at least on a number of non-overlapped/new variants. For instance, in the given example, after selecting X (i.e., the deployment domain with maximum number of variants), Z will be selected over Y because Z would bring in 4 newer variants while Y would bring 3 newer variants. Therefore, in the given example a set of the ordered deployment domains based on the order of the X, Y and Z deployment domains i.e. X, Z and Y, is generated.

Also, in another example, if X, Y and Z deployment domains have 10, 6, and 8 variants, respectively. And, X and Y have 3 common variants while X and Z also have 4 common variants. A set of the ordered deployment domains is generated based at least on a number of non-overlapped/new variants. For instance, in the given example, after selecting X (i.e. the deployment domain with maximum number of variants), Z will be selected over Y because Z would bring in 4 newer variants while Y would bring 3 newer variants. Therefore, in the given example a set of the ordered deployment domains based on the order of the X, Y and Z deployment domains i.e. X, Z and Y, is generated. Also, in yet another example the processing unit [104] is configured to generate the set of ordered deployment domains such that a deployment domain having a maximum number of variants will rank first followed by a deployment domain having lesser variants compared to it. Furthermore, considering the above example, where 3 unordered deployment domains A, B and C are received at the processing unit [102] and a set of plurality of electronic devices' variants corresponding to each of the A, B and C deployment domains comprising 15, 12 and 19 variants of an electronic device, respectively, is identified by the identification unit [104]. Let assume said 15, 12 and 19 variants are unique and non-overlapping. The processing unit [104] in the given example is further configured to order the A, B and C deployment domains based on the identified number of electronic devices' variants in the set of plurality of electronic devices' variants corresponding to the A, B and C deployment domains. More particularly, the processing unit [102] is configured to order the A, B and C deployment domains in C, A and B order i.e. based on the identified 15, 12 and 19 electronic device variants in the set of plurality of electronic devices' variants corresponding to each of the A, B and C deployment domains, respectively. Thereafter, once the A, B and C deployment domains are ordered in a C, A and B order, a set of the ordered deployment domains based on the order of the A, B and C deployment domains i.e. C, A and B, is generated.

Further, in an implementation, the processing unit [102] is further configured to verify and deploy a change in one or more electronic devices' variants present in each set of plurality of electronic devices' variants based on the specific order of each deployment domain in the set of ordered deployment domains. For instance, considering the above example, where the A, B and C deployment domains are ordered in a C, A and B order and the set of the ordered deployment domains based on the order of the A, B and C deployment domains i.e. C, A and B, is generated. The processing unit [102] in such instance is further configured to verify and deploy a change in one or more electronic devices' variants present in each set of plurality of electronic devices' variants corresponding to the A, B and C deployment domains, based on the specific order of the A, B and C deployment domains in the set of ordered deployment domains (i.e. C, A and B). More particularly, one or more electronic devices' variants from the 19, 15 and 12 electronic device variants of C, A and B deployment domains respectively, are verified. Furthermore, the one or more electronic devices' variants are verified to further deploy all electronic devices' variants present in each set of plurality of electronic devices' variants, based on the verification of the one or more electronic devices' variants in the specific order.

Furthermore, in an implementation, the identification unit [104] is further configured to identify a number of electronic devices associated with each set of plurality of electronic devices' variants. Also, the processing unit [102] is further configured to generate, the set of ordered deployment domains based on a minimum number of electronic devices associated with each set of plurality of electronic devices' variants. More particularly, the processing unit [102] is configured to generate, the set of ordered deployment domains based on maximizing the cumulative number of electronic devices' variants with each set of plurality of electronic devices' variants of each deployment domain, the minimum number of electronic devices associated with each set of plurality of electronic devices' variants and the pre-defined SLA. For example, if 400 and 200 electronic devices are identified to be associated with a set of plurality of electronic devices' variants of two deployment domains A and B, respectively, and the set of plurality of electronic devices' variants of the deployment domain A comprises 15 unique variants and the set of plurality of electronic devices' variants of the deployment domain B comprises 20 unique variants, the processing unit [102] is configured to generate, the set of ordered deployment domains comprising deployment domain B followed by deployment domain A, based on the identified number of electronic devices i.e. 400 and 200, the number of electronic devices' variants in each set of plurality of electronic devices' variants i.e. 15 and 20 and the pre-defined SLA threshold. Also, in another example if 150, 300 and 250 electronic devices are identified to be associated with a set of plurality of electronic devices' variants of three deployment domains X, Y and Z, respectively. The set of plurality of electronic devices' variants of the deployment domain X comprises 14 variants, the set of plurality of electronic devices' variants of the deployment domain Y comprises 6 variants and the set of plurality of electronic devices' variants of the deployment domain Z comprises 8 variants. Also, a total number of unique variants in the given example is 20 and there are 5 overlapping variants in the deployment domains X and Y and 3 overlapping variants in the deployment domains X and Z with no common variant between Y and Z. Further, in the given example a set of ordered deployment domains will be generated based on the implementation of the features of the present invention by firstly selecting X (i.e., the deployment domain with maximum number of variants and a minimum number of electronic devices), followed by Z (i.e. the deployment domain which cumulatively takes the number of unique variants covered to 19 by bringing in 5 newer variants as opposed to deployment domain Y which would have cumulatively taken the number of unique variants covered to 15 by bringing in only 1 newer variant) and Y, respectively. Therefore, in the given example a set of the ordered deployment domains based on the order of the X, Y and Z deployment domains i.e. X, Z and Y, is generated.

Thereafter, the processing unit [102] is configured to verify and deploy a change in one or more electronic devices' variants present in each set of plurality of electronic devices' variants based on the specific order of each deployment domain in the set of ordered deployment domains. Furthermore, the one or more electronic devices' variants are verified to further deploy all electronic devices' variants present in each set of plurality of electronic devices' variants, based on the verification of the one or more electronic devices' variants in the specific order.

Further, in an implementation, the identification unit [104], is further configured to identify a set of unique electronic devices' variants from each set of plurality of electronic devices' variants present in each deployment domain. For example, if a set of plurality of electronic devices' variants present in a deployment domain comprises of 7 electronic devices with following exemplary configuration parameters that may be used to define a unique variant:

Electronic Device1: Server Type X1, Operating System (OS) Y1

Electronic Device2: Server Type X1, Operating System (OS) Y1

Electronic Device3: Server Type X1, Operating System (OS) Y2

Electronic Device4: Server Type X1, Operating System (OS) Y2

Electronic Device5: Server Type X2, Operating System (OS) Y1

Electronic Device6: Server Type X2, Operating System (OS) Y1

Electronic Device7: Server Type X1, Operating System (OS) Y1

Then in the given example each of the 7 electronic devices are mapped to a variant resulting into variants as given below:

Electronic Device1: Server Type X1, OS Y1-Variant V1

Electronic Device2: Server Type X1, OS Y1-Variant V1

Electronic Device3: Server Type X1, OS Y2-Variant V2

Electronic Device4: Server Type X1, OS Y2-Variant V2

Electronic Device5: Server Type X2, OS Y1-Variant V3

Electronic Device6: Server Type X2, OS Y1-Variant V3

Electronic Device7: Server Type X1, OS Y1-Variant V1

Further, in the given example the identification unit [104], is configured to identify V1, V2 and V3 as the set of unique electronic devices' variants from the set of plurality of electronic devices' variants (i.e., V1, V1, V2, V2, V3, V3 and V1) present in the given exemplary deployment domain. Therefore, in the given example out of 7 variants, 3 are unique and the remaining are repeated.

Also, the identification unit [104] is thereafter configured to identify at least, a least number of electronic devices associated with each set of unique electronic devices' variants. For instance, in the above example where the set of plurality of electronic devices' variants present in a deployment domain comprises 7 variants of 7 electronic devices and out of 7 variants 3 variants are unique and are associated with 7 electronic devices, the identification unit [104] is configured to identify at least 3 electronic devices (say Electronic Device 1 for Variant 1, Electronic Device 3 for Variant 2 and Electronic Device 5 for Variant 3) associated with the set of unique electronic devices' variants comprising the 3 unique variants (i.e., V1, V2 and V3).

Thereafter, processing unit [102] is further configured to generate a subdomain in each deployment domain based on the set of unique electronic devices' variants associated with said each deployment domain and a minimum number of electronic devices associated with said set of unique electronic devices' variants. Furthermore, considering the above stated example, a subdomain based on the set of unique electronic devices' variants comprising the 3 unique variants and 3 electronic devices (i.e., the least number of electronic devices) is generated.

The identification unit [104] is further configured to identify, a number of variants in each set of unique electronic devices' variants. For example, in the above example, the identification unit [104] is further configured to identify 3 variants in the set of unique electronic devices' variants.

Also, processing unit [102] is further configured to arrange one or more subdomains associated with one or more deployment domains in a specific order based on maximizing a cumulative number of electronic devices' variants with each set of unique electronic devices' variants of each subdomain of the one or more subdomains, the minimum number of electronic devices associated with each set of unique electronic devices' variants and the pre-defined SLA threshold. For example, if three subdomains A, B and C of three deployment domains X, Y and Z respectively, follow a pre-defined SLA criteria and comprise 15, 18 and 21 unique electronic devices' variants, respectively. Further, the 15, 18 and 21 unique electronic devices' variants of the subdomains A, B and C are associated with 15, 18 and 21 electronic devices respectively. In such an instance, the processing unit [102] is configured to arrange the subdomains A, B and C in C, B and A order.

Thereafter, the processing unit [102] is further configured to generate the set of ordered deployment domains based on the arrangement of the one or more subdomains associated with the one or more deployment domains in the specific order. For instance, in the above example where the subdomains A, B and C are arranged in the C, B and A order, the processing unit [102] is configured to generate the set of ordered deployment domains i.e. Z, Y and X based on the arrangement of the subdomains A, B and C of the deployment domains X, Y and Z respectively, in the C, B and A order.

Also, the processing unit [102] is further configured to verify and deploy a change in one or more electronic devices' variants present in each set of unique electronic devices' variants based on the specific order of the one or more subdomains in the set of ordered deployment domains. For instance, in the above example, one or more electronic devices' variants from the 21, 18 and 15 unique electronic devices' variants, respectively are verified by the processing unit [102], based on the C, B and A order of the subdomains in the set of ordered deployment domains comprising deployment domains in order Z, Y and X. Furthermore, the one or more electronic devices' variants are verified to further deploy all electronic devices' variants present in each set of unique electronic devices' variants, based on the verification of the one or more electronic devices' variants in the specific order.

Furthermore, in an implementation, the processing unit [102] is further configured to merge two or more subdomains to maximize a number of electronic devices' variants in the resultant merged domain along with a reduced number of electronic devices in the resultant merged domain subject to honoring the pre-defined SLA constraints. Also, the reduced number of electronic devices is a number of electronic devices lesser than a number of electronic devices associated with a set of unique electronic devices' variants of said two or more subdomains. For example, if three subdomains A, B and C of three deployment domains X, Y and Z respectively, follows a pre-defined SLA criteria and comprises 12, 15 and 28 unique electronic devices' variants, respectively. Further, the 12, 15 and 28 unique electronic devices' variants of the subdomains A, B and C are associated with 12, 15 and 28 electronic devices respectively. Also, out of the 12, 15 and 28 unique electronic devices' variants, 10 variants associated with 10 repeating electronic devices are the same. In such an instance, the processing unit [102] is configured to merge the three subdomains A, B and C such that the resultant merged domain comprises 45 variants and 45 electronic devices. Also, in an implementation one or more resultant merged domains may be arranged in a specific order to generate the set of ordered deployment domains, based on the implementation of the features of the present invention.

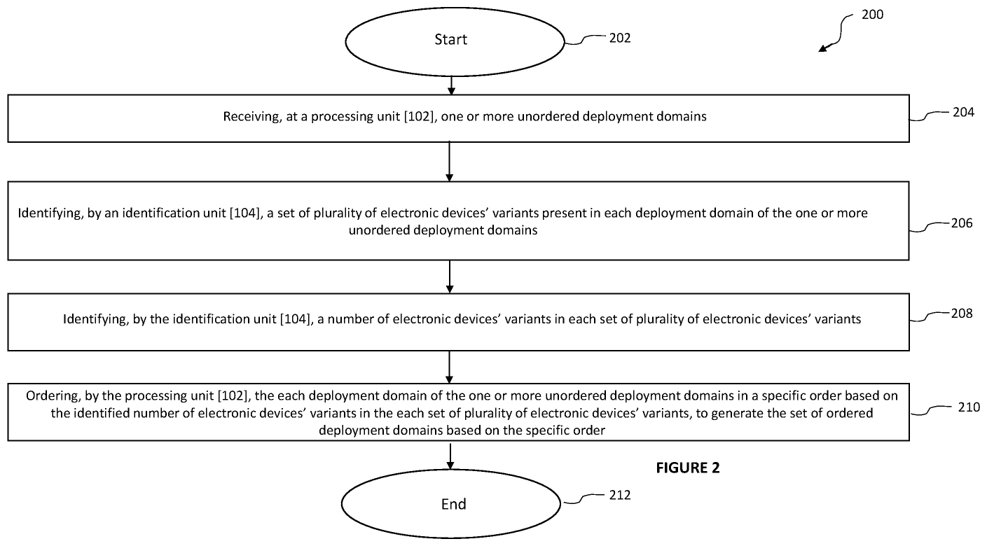

Referring to FIG. 2, an exemplary method flow diagram [200], depicting a method for generating a set of ordered deployment domains, in accordance with exemplary embodiments of the present invention is shown. In an implementation the method can be implemented at a server. As shown in FIG. 2, the method begins at step [202].

At step [204], the method comprises receiving, at a processing unit [102], one or more unordered deployment domains. The one or more unordered deployment domains are created via at least one generally followed method of creation of an unordered deployment domain. For example, the one or more unordered deployment domains may be created by at least one of a Planned Maintenance Domain (PMD) method, Static Maintenance Domain (SMD) method, PMD-SMD Hybrid Maintenance Domain method and the like methods known in the art. Also, the one or more unordered deployment domains are created based on one or more required constraints such as including but not limited to a pre-defined SLA constraint. Further, once the one or more unordered deployment domains are created, the method encompasses receiving the same, at the processing unit [102].

Next, at step [206], the method comprises identifying, by an identification unit [104], a set of plurality of electronic devices' variants present in each deployment domain of the one or more unordered deployment domains. In an implementation the set of plurality of electronic devices' variants may comprise one or more variants of one or more electronic devices. For example, if 4 unordered deployment domains are received at the processing unit [102] and each unordered deployment domain comprises 20 variants of 20 electronic devices, the method encompasses identifying by the identification unit [104], in each unordered deployment domain form the 4 unordered deployment domains, a set of electronic devices' variants. In the given example, the method comprises identifying by the identification unit [104], 4 sets of electronic devices' variants, each corresponding to each of the 4 unordered deployment domains, wherein each set of electronic devices' variants comprises 20 variants of 20 electronic devices.

Thereafter, at step [208], the method comprises identifying, by the identification unit [104], a number of electronic devices' variants in each set of plurality of electronic devices' variants. For instance, in the above example, the method encompasses identifying by the identification unit [104], 20 electronic device variants in each set from the 4 sets of plurality of electronic devices' variants, wherein each set of plurality of electronic devices' variants is corresponding to each of the 4 unordered deployment domains. Therefore, for each unordered deployment domain, a set of plurality of electronic devices' variants, and a number of electronic devices' variants present in said set of plurality of electronic devices' variants is identified by the identification unit [104].

Next, at step [210], the method comprises ordering, by the processing unit [102], each deployment domain of the one or more unordered deployment domains in a specific order based on the identified number of electronic devices' variants in each set of plurality of electronic devices' variants, to generate the set of ordered deployment domains based on the specific order. For example, if 3 unordered deployment domains A, B and C are received at the processing unit [102] and a set of plurality of electronic devices' variants corresponding to each of the A, B and C deployment domains comprising 10, 15 and 20 variants of an electronic device, respectively, is identified by the identification unit [104]. Thereafter, in the given example, the method encompasses ordering by the processing unit [104], the A, B and C deployment domains based on the identified number of electronic devices' variants in the set of plurality of electronic devices' variants corresponding to the A, B and C deployment domains i.e. the identified 10, 15 and 20 electronic device variants. Thereafter, once the A, B and C deployment domains are ordered in a specific order, the method encompasses generating a set of the ordered deployment domains based on the order of the A, B and C deployment domains.

Also, in an implementation, the method further comprises generating by the processing unit [102], the set of ordered deployment domains based on maximizing a cumulative number of electronic devices' variants with each set of plurality of electronic devices' variants of each deployment domain. More specifically, the method firstly encompasses identifying by the processing unit [102] one or more overlapped variants in two or more sets of plurality of electronic devices' variants of one or more deployment domains. Thereafter, the method encompasses generating by the processing unit [104], the set of ordered deployment domains such that a deployment domain having a maximum number of variants will rank first followed by a deployment domain from among the remaining deployment domains having: maximum number of unique variants that are not already covered by the deployment domains that have already been ordered. For example, if there are three deployment domains Q, B and Z, wherein each of the three deployment domains having 10 variants, 7 variants and 8 variants respectively. Also, a total number of unique variants in the given example is 15 and there are 4 overlapping variants in the deployment domains Q and B and 6 overlapping variants in the deployment domains Q and Z. Further, in the given example a set of ordered deployment domains will be generated based on the implementation of the features of the present invention by firstly selecting the deployment domain with maximum number of variants i.e. Q, followed by B (i.e. deployment domain with least number of overlapped variants and higher number of new variants (i.e. 3 non-overlapped variants)) and Z (i.e. deployment domain with maximum number of overlapped variants and a lower number of new variants (i.e. 2 non-overlapped variants)), respectively. Therefore, in the given example a set of the ordered deployment domains based on the order of the Q, B and Z deployment domains i.e. Q, B and Z, is generated. Also, in an example the method encompasses generating by the processing unit [104], the set of ordered deployment domains such that a deployment domain having a maximum number of variants will rank first followed by a deployment domain having lesser variants compared to it. Furthermore, considering the above example, where 3 unordered deployment domains A, B and C are received at the processing unit [102] and a set of plurality of electronic devices' variants corresponding to each of the A, B and C deployment domains comprising 10, 15 and 20 variants of an electronic device, respectively, is identified by the identification unit [104]. Let assume said 10, 15 and 20 variants are unique and non-overlapping. The method in the given example further comprises ordering by the processing unit [104], the A, B and C deployment domains based on the identified number of electronic devices' variants in the set of plurality of electronic devices' variants corresponding to the A, B and C deployment domains. More particularly, the method encompasses ordering by the processing unit [102], the A, B and C deployment domains in C, B and A order i.e. based on the identified 10, 15 and 20 electronic device variants in the set of plurality of electronic devices' variants corresponding to each of the A, B and C deployment domains, respectively. Thereafter, once the A, B and C deployment domains are ordered in a C, B and A order, a set of the ordered deployment domains based on the order of the A, B and C deployment domains i.e. C, B and A, is generated.

Further, in an implementation, the method encompasses verifying and deploying by the processing unit [102], a change in one or more electronic devices' variants present in each set of plurality of electronic devices' variants based on the specific order of each deployment domain in the set of ordered deployment domains. For instance, considering the above example, where the A, B and C deployment domains are ordered in a C, B and A order and the set of the ordered deployment domains based on the order of the A, B and C deployment domains i.e. C, B and A, is generated. The method in such instance encompasses verifying and deploying by the processing unit [102], a change in one or more electronic devices' variants present in each set of plurality of electronic devices' variants corresponding to the A, B and C deployment domains, based on the specific order of the A, B and C deployment domains in the set of ordered deployment domains (i.e. C, B and A). More particularly, one or more electronic devices' variants from the 10, 15 and 20 electronic device variants of C, B and A deployment domains respectively, are verified in that order. Furthermore, a change in all electronic devices' variants present in each set of plurality of electronic devices' variants is deployed based on the verification of the one or more electronic devices' variants in the specific order.

Furthermore, the method also comprises identifying, by the identification unit [104], a number of electronic devices associated with each set of plurality of electronic devices' variants. Also, the method further comprises generating by the processing unit [102], the set of ordered deployment domains based on a minimum number of electronic devices associated with each set of plurality of electronic devices' variants. More particularly, the method encompasses generating by the processing unit [102], the set of ordered deployment domains based on maximizing the cumulative number of electronic devices' variants with each set of plurality of electronic devices' variants of each deployment domain, the minimum number of electronic devices associated with each set of plurality of electronic devices' variants and the pre-defined SLA threshold. For example, if 600 and 400 electronic devices are identified to be associated with a set of plurality of electronic devices' variants of two deployment domains A and B, respectively, and the set of plurality of electronic devices' variants of the deployment domain A comprises 19 unique variants and the set of plurality of electronic devices' variants of the deployment domain B comprises 25 unique variants. In an event when the SLA conditions are met, the method in the given example encompasses generating by the processing unit [102], the set of ordered deployment domains comprising deployment domain B followed by deployment domain A, based on the identified number of electronic devices i.e. 600 and 400, the number of electronic devices' variants in each set of plurality of electronic devices' variants i.e. 19 and 25. Also, in another example if 200, 400 and 300 electronic devices are identified to be associated with a set of plurality of electronic devices' variants of three deployment domains X, Y and Z, respectively. The set of plurality of electronic devices' variants of the deployment domain X comprises 14 variants, the set of plurality of electronic devices' variants of the deployment domain Y comprises 6 variants and the set of plurality of electronic devices' variants of the deployment domain Z comprises 8 variants. Also, a total number of unique variants in the given example is 20 and there are 5 overlapping variants in the deployment domains X and Y and 3 overlapping variants in the deployment domains X and Z with no common variant between Y and Z. Further, in the given example a set of ordered deployment domains will be generated based on the implementation of the features of the present invention by firstly selecting X (i.e., the deployment domain with maximum number of variants and a minimum number of electronic devices), followed by Z (i.e. the deployment domain which cumulatively takes the number of unique variants covered to 19 by bringing in 5 newer variants as opposed to deployment domain Y which would have cumulatively taken the number of unique variants covered to 15 by bringing in only 1 newer variant) and Y, respectively. Therefore, in the given example a set of the ordered deployment domains based on the order of the X, Y and Z deployment domains i.e. X, Z and Y, is generated.

Further, the method comprises verifying and deploying by the processing unit [102], a change in one or more electronic devices' variants present in said each set of plurality of electronic devices' variants based on the specific order of each deployment domain in the set of ordered deployment domains. Furthermore, the one or more electronic devices' variants are verified to further deploy the change to all electronic devices' variants present in each set of plurality of electronic devices' variants, based on the verification of the one or more electronic devices' variants in the specific order.

Further, in an implementation, the method also comprises identifying, by the identification unit [104 ], a set of unique electronic devices' variants from each set of plurality of electronic devices' variants present in each deployment domain. For example, if a set of plurality of electronic devices' variants present in a deployment domain comprises of 6 electronic devices with following exemplary configuration parameters that may be used to define a unique variant:

Electronic Device1: Server Type X1, Operating System (OS) Y1

Electronic Device2: Server Type X1, Operating System (OS) Y2

Electronic Device3: Server Type X1, Operating System (OS) Y2

Electronic Device4: Server Type X1, Operating System (OS) Y1

Electronic Device5: Server Type X2, Operating System (OS) Y1

Electronic Device6: Server Type X2, Operating System (OS) Y1

Then in the given example each of the 6 electronic devices are mapped to a variant resulting into variants as given below:

Electronic Device1: Server Type X1, Operating System (OS) Y1-Variant V1

Electronic Device2: Server Type X1, Operating System (OS) Y2-Variant V2

Electronic Device3: Server Type X1, Operating System (OS) Y2-Variant V2

Electronic Device4: Server Type X1, Operating System (OS) Y1-Variant V1

Electronic Device5: Server Type X2, Operating System (OS) Y1-Variant V3

Electronic Device6: Server Type X2, Operating System (OS) Y1-Variant V3

Further, in the given example the method encompasses identifying by the identification unit [104 ], V1, V2 and V3 as the set of unique electronic devices' variants from the set of plurality of electronic devices' variants (i.e., V1, V2, V2, V1, V3 and V3) present in the given exemplary deployment domain. Therefore, in the given example out of 6 variants, 3 are unique and the remaining are repeated.

Thereafter, the method leads to identifying, by the identification unit [104], at least, a least number of electronic devices associated with each set of unique electronic devices' variants. For instance, in the above example where the set of plurality of electronic devices' variants present in a deployment domain comprises 6 variants of 6 electronic devices and out of 6 variants 3 variants are unique and are associated with 6 electronic devices, the method encompasses identifying by the identification unit [104], 3 electronic devices (say Electronic Device 1 for Variant 1, Electronic Device 2 for Variant 2 and Electronic Device 5 for Variant 3) associated with the set of unique electronic devices' variants comprising the 3 unique variants (i.e., V1, V2 and V3).

The method thereafter encompasses generating, by the processing unit [102], a subdomain in each deployment domain based on the set of unique electronic devices' variants associated with said each deployment domain and a minimum number of electronic devices associated with said set of unique electronic devices' variants. Furthermore, considering the above stated example, a subdomain based on the set of unique electronic devices' variants comprising the 3 unique variants and 3 electronic devices (i.e., the least number of electronic devices) is generated.

Also, the method further comprises identifying, by the identification unit [104], a number of variants in each set of unique electronic devices' variants. For example, in the above example, the method comprises identifying by the identification unit [104], 3 variants in the set of unique electronic devices' variants.

Thereafter, the method comprises arranging one or more subdomains associated with one or more deployment domains in a specific order based on maximizing a cumulative number of electronic devices' variants with each set of unique electronic devices' variants of each subdomain of the one or more subdomains, the minimum number of electronic devices associated with each set of unique electronic devices' variants and the pre-defined SLA threshold. For example, if three subdomains A, B and C of three deployment domains X, Y and Z respectively, follows a pre-defined SLA threshold criteria and comprises 10, 15 and 20 unique electronic devices' variants, respectively. Further, the 10, 15 and 20 unique electronic devices' variants of the subdomains A, B and C are associated with 10, 15 and 20 electronic devices respectively. In such an instance, the method encompasses arranging by the processing unit [102], the subdomains A, B and C in C, B and A order.

Next, the method encompasses generating by the processing unit [102], the set of ordered deployment domains based on the arrangement of the one or more subdomains associated with the one or more deployment domains in the specific order. For instance, in the above example where the subdomains A, B and C are arranged in the C, B and A order, the method encompasses generating by the processing unit [102], the set of ordered deployment domains i.e. Z, Y and X based on the arrangement of the subdomains A, B and C of the deployment domains X, Y and Z respectively, in the C, B and A order.

Further, the method also comprises verifying and deploying a change in one or more electronic devices' variants present in each set of unique electronic devices' variants based on the specific order of the one or more subdomains in the set of ordered deployment domains. For instance, in the above example, the method encompasses verifying and deploying by the processing unit [102], one or more electronic devices' variants from the 20, 15 and 10 unique electronic devices' variants, respectively, based on the C, B and A order of the subdomains in the set of ordered deployment domains comprising deployment domains in order Z, Y and X. Furthermore, the one or more electronic devices' variants are verified to further deploy all electronic devices' variants present in said each set of unique electronic devices' variants, based on the verification of the one or more electronic devices' variants in the specific order.

Also, in an implementation, the method further comprises merging two or more subdomains to maximize a number of electronic devices' variants in the resultant merged domain along with a reduced number of electronic devices in the resultant merged domain subject to honouring the pre-defined SLA constraints. Also, the reduced number of electronic devices is a number of electronic devices lesser than a number of electronic devices associated with a set of unique electronic devices' variants of said two or more subdomains. For example, if three subdomains A, B and C of three deployment domains X, Y and Z respectively, follows a pre-defined SLA criteria and comprises 11, 14 and 27 unique electronic devices' variants, respectively. Further, the 11, 14 and 27 unique electronic devices' variants of the subdomains A, B and C are associated with 11, 14 and 27 electronic devices respectively. Also, out of the 11, 14 and 27 unique electronic devices' variants, 10 variants associated with 10 repeating electronic devices are the same. In such an instance, the method encompasses merging by the processing unit [102], the three subdomains A, B and C such that the resultant merged domain comprises 43 variants and 43 electronic devices. Also, in an implementation one or more resultant merged domains may be arranged in a specific order to generate the set of ordered deployment domains, based on the implementation of the features of the present invention.

Thereafter, the method terminates at step [212].

As is evident from the above disclosure, the present invention provides a novel solution for generating a set of ordered deployment domains. More particularly, the present invention provides a solution which takes into account different variants of devices of a kind while generating a set of ordered deployment domains. Also, the present invention provides a solution to generate an ordered list of deployment domains to efficiently and effectively deploy all variants present in one or more ordered deployment domains. Furthermore, the present invention provides a solution to optimize a number of variants covered with each deployment domain picked in an order of deployment. Also, the present invention provides a solution to generate initial deployment domains with minimal number of devices, to verify that a change verified on a particular number of variants works the intended way on all variants.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for generating a set of ordered deployment domains, the method comprises:
receiving, at a processing unit [102], one or more unordered deployment domains;
identifying, by an identification unit [104], a set of plurality of electronic devices' variants present in each deployment domain of the one or more unordered deployment domains;
identifying, by the identification unit [104], a number of electronic devices' variants in each set of plurality of electronic devices' variants;
ordering, by the processing unit [102], each deployment domain of the one or more unordered deployment domains in a specific order based on the identified number of electronic devices' variants in each set of plurality of electronic devices' variants, to generate the set of ordered deployment domains based on the specific order.

2. The method as claimed in claim 1, the method further comprises verifying and deploying a change in one or more electronic devices' variants present in each set of plurality of electronic devices' variants based on the specific order of each deployment domain in the set of ordered deployment domains.

3. The method as claimed in claim 1, the method further comprises generating by the processing unit [102], the set of ordered deployment domains based on maximizing a cumulative number of electronic devices' variants with each set of plurality of electronic devices' variants of each deployment domain.

4. The method as claimed in claim 1, the method further comprises identifying, by the identification unit [104], a number of electronic devices associated with each set of plurality of electronic devices' variants.

5. The method as claimed in claim 4, the method further comprises generating by the processing unit [102], the set of ordered deployment domains based on a minimum number of electronic devices associated with each set of plurality of electronic devices' variants.

6. The method as claimed in claim 1, the method further comprises:
identifying, by the identification unit [104], a set of unique electronic devices' variants from each set of plurality of electronic devices' variants present in each deployment domain;
identifying, by the identification unit [104], a number of electronic devices associated with each set of unique electronic devices' variants; and
generating, by the processing unit [102], a subdomain in each deployment domain based on the set of unique electronic devices' variants associated with said each deployment domain and a minimum number of electronic devices associated with said set of unique electronic devices' variants.

7. The method as claimed in claim 6, the method further comprises identifying, by the identification unit [104], a number of variants in each set of unique electronic devices' variants.

8. The method as claimed in claim 6, the method further comprises arranging one or more subdomains associated with one or more deployment domains in a specific order based on maximizing a cumulative number of electronic devices' variants with each set of unique electronic devices' variants of each subdomain of the one or more subdomains, the minimum number of electronic devices associated with each set of unique electronic devices' variants and the pre-defined SLA threshold.

9. The method as claimed in claim 6, the method further comprises generating by the processing unit [102], the set of ordered deployment domains based on the arrangement of the one or more subdomains associated with the one or more deployment domains in the specific order.

10. The method as claimed in claim 9, the method further comprises verifying and deploying a change in one or more electronic devices' variants present in each set of unique electronic devices' variants based on the specific order of the one or more subdomains in the set of ordered deployment domains.

11. The method as claimed in claim 9, the method further comprises merging two or more subdomains to maximize a number of electronic devices' variants in resultant merged domain along with a reduced number of electronic devices in the resultant merged domain based on the pre-defined SLA threshold.

12. The method as claimed in claim 11, wherein the reduced number of electronic devices is a number of electronic devices lesser than a number of electronic devices associated with a set of unique electronic devices' variants of said two or more subdomains.

13. A system for generating a set of ordered deployment domains, the system comprises:
a processing unit [102], configured to receive one or more unordered deployment domains;
an identification unit [104], configured to identify:
a set of plurality of electronic devices' variants present in each deployment domain of the one or more unordered deployment domains, and
a number of electronic devices' variants in each set of plurality of electronic devices' variants; wherein
the processing unit [102] is further configured to order, each deployment domain of the one or more unordered deployment domains in a specific order, based on the identified number of electronic devices' variants in each set of plurality of electronic devices' variants, to generate the set of ordered deployment domains based on the specific order.

14. The system as claimed in claim 13, wherein the processing unit [102] is further configured to verify and deploy a change in one or more electronic devices' variants present in each set of plurality of electronic devices' variants based on the specific order of each deployment domain in the set of ordered deployment domains.

15. The system as claimed in claim 13, wherein the processing unit [102] is further configured to generate the set of ordered deployment domains based on maximizing a cumulative number of electronic devices' variants with each set of plurality of electronic devices' variants of each deployment domain.

16. The system as claimed in claim 13, wherein the identification unit [104] is further configured to identify a number of electronic devices associated with each set of plurality of electronic devices' variants.

17. The system as claimed in claim 14, wherein the processing unit [102] is further configured to generate, the set of ordered deployment domains based on a minimum number of electronic devices associated with each set of plurality of electronic devices' variants.

18. The system as claimed in claim 13, wherein the identification unit [104], is further configured to identify:
a set of unique electronic devices' variants from each set of plurality of electronic devices' variants present in each deployment domain, and
a number of electronic devices associated with each set of unique electronic devices' variants; wherein:
the processing unit [102] is further configured to generate a subdomain in each deployment domain based on the set of unique electronic devices' variants associated with said each deployment domain and a minimum number of electronic devices associated with said set of unique electronic devices' variants.

19. The system as claimed in claim 18, wherein the identification unit [104] is further configured to identify, a number of variants in each set of unique electronic devices' variants.

20. The system as claimed in claim 18, wherein the processing unit [102] is further configured to arrange one or more subdomains associated with one or more deployment domains in a specific order based on maximizing a cumulative number of electronic devices' variants with each set of unique electronic devices' variants of each subdomain of the one or more subdomains, the minimum number of electronic devices associated with each set of unique electronic devices' variants and the pre-defined SLA threshold.

21. The system as claimed in claim 18, wherein the processing unit [102] is further configured to generate, the set of ordered deployment domains based on the arrangement of the one or more subdomains associated with the one or more deployment domains in the specific order.

22. The system as claimed in claim 21, wherein the processing unit [102] is further configured to verify and deploy a change in one or more electronic devices' variants present in each set of unique electronic devices' variants based on the specific order of the one or more subdomains in the set of ordered deployment domains.

23. The system as claimed in claim 21, wherein the processing unit [102] is further configured to merge two or more subdomains to maximize a number of electronic devices' variants in resultant merged domain along with a reduced number of electronic devices in the resultant merged domain based on the pre-defined SLA threshold.

24. The system as claimed in claim 23, wherein the reduced number of electronic devices is a number of electronic devices lesser than a number of electronic devices associated with a set of unique electronic devices' variants of said two or more subdomains.
